(19) United States
(12) Patent Application Publication
(10) Pub. No.: US 2013/0343843 A1
(43) Pub. Date: Dec. 26, 2013

(54) AUTOMATED STORAGE AND HANDLING SYSTEMS

(71) Applicants: Subramanian Venkataraman, Chennai (IN); Guruprasad Venkataraman, Chennai (IN)

(72) Inventors: Subramanian Venkataraman, Chennai (IN); Guruprasad Venkataraman, Chennai (IN)

(21) Appl. No.: 14/022,748

(22) Filed: Sep. 10, 2013

Related U.S. Application Data
(63) Continuation of application No. PCT/IN2012/000035, filed on Jan. 12, 2012.

(30) Foreign Application Priority Data
Mar. 11, 2011 (IN) 738/CHE/2011

(51) Int. Cl. B65G 1/04

(52) U.S. Cl. CPC B65G 1/04
USPC 414/277; 414/807

(57) ABSTRACT

Automated handling systems move container through storage facilities with transfer elements that move to storage spaces, to an elevator, a margin space, and/or to a loading/unloading point. Different assemblies, arms, and structures are useable in these areas, including multiple arms and assemblies to uniformly and automatically move containers through the several different system parts. Containers may be fully-supported while stationary or moving by the handling systems, and securing structures, drives, and/or sensors are useable with each of the arms, assemblies, and spaces. A universal controller can communicate with and control every element of the systems, permitting coordinated and automated handling of many containers throughout the system. Storage and/or retrieval algorithms for containers may be programmed into the controller to automatically move containers from/to a loading/unloading point to/from a storage space.

### RELATED APPLICATIONS

This application claims priority under 35 U.S.C. §120 to, and is a continuation of, co-pending International Application PCT/IN2012/000035, filed Jan. 12, 2012 and designating the US. This application also claims priority under 35 U.S.C. §119 to Indian Application 738/CHE/2011, filed Mar. 11, 2011, such Indian Application also serving as the earliest claimed priority for the International Application. These Indian and International applications are incorporated by reference herein in their entireties.

### SUMMARY

Example embodiment automated storage and retrieval systems work with storage facilities where many containers of various size are processed through a loading/unloading area and stored in assigned spaces for selective or filo access. Example embodiment systems include transfer elements that allow for end-to-end automated storage and handling, including, for example, transfer assemblies that move to the assigned spaces with an arm that can move a container from/to a storage space onto/from such an assembly and move the containers between an elevator and/or loading/unloading point.

Different assemblies and/or arms are useable in example embodiments, including multiple arms and assemblies to uniformly and automatically move containers through several different system parts such as a storage facility/storage space, elevator, buffer area, and a loading/unloading area. Fully-supporting structures may be used throughout the arms, assemblies, and various spaces, including bottom-supporting rollers or arrests that support each container about a substantial portion of their bottoms, while permitting or preventing movement of containers at desired times. Assemblies and arms may further extend upward to contact and move containers, providing further bottom support without a need for pallets or stress on container reinforcements. A variety of securing structures, drives, and/or sensors are useable with each of the arms, assemblies, and spaces to secure and detect desired container movement.

A computerized, processor-driven controller can control every element of example embodiment systems, permitting coordinated and automated storage, retrieval, and handling of multiple containers simultaneously. Example methods are useable with example embodiments to store and/or retrieve containers in/from a storage facility. For example, the controller may be programmed with routines of example methods and control various systems to integrally move containers from/to a loading/unloading point to/from an assigned storage space.

### BACKGROUND

Material handling plays a considerable role in any industry, be it a project, a manufacturing activity, or a service industry. Handling requires consideration of the type, size, shape, weight, and quantity of the material to be handled as well as the transport distance, elevation, pressure, cycle, temperature, environment, purpose, and economics of the handling. Various handling equipment and techniques are used in different combinations to achieve these desired results. One known handling environment includes loading and unloading onto/from trucks and other vehicles at container terminals.

Container terminals across the world are subject to high utilization and increasing demand. Of all the components/processes in terminal operations, container handling and storage plays a crucial role in determining capacity. A terminal's capacity, measured in Twenty-Foot Equivalent Unit/Hectare (TEU/Ha), is constrained by handling and storage. Currently ports are operating between 22,000 TEU/Ha and 29,000 TEU/Ha. Most of the ports run at around 27,000 TEU/Ha.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment handling and storage system showing a storage tower with containers on different tiers.

FIG. 2 is a schematic of the example embodiment system showing an elevator, addressed storage slots, containers, and transfer module on a track on a causeway.

FIG. 3 is an illustration of an example embodiment transfer module assembly (top and side view) with components and track.

FIG. 4 is an illustration of an example embodiment side structure useable with a transfer module.

FIG. 5 is an illustration of an example embodiment transfer arm assembly (top and side view) with lifting devices and a drive.

FIG. 6 is an illustration of an example embodiment elevator cage assembly (top and side view) with power arm and fixed track.

FIG. 7 is an illustration of an example embodiment power arm assembly (top and side view) with drive and lifting devices, useable as an elevator power arm and buffering bay power arm.

FIG. 8 is an illustration of an example embodiment addressed storage slot (top and side view) with supports and track.

FIG. 9 is an illustration of an example embodiment transfer station.

FIG. 10 is an illustration of an example embodiment buffering bay (top and side view) with power arm and side supports, showing containers in transit position.

FIG. 11 is an illustration of an example embodiment transfer equipment (top and side view) with lifting grab and container.

FIG. 12 is a flow chart showing an example method of storing and handling containers.

FIG. 13 is a flow chart showing an example method of retrieving and handling containers.

FIG. 14 is an illustration of a further example embodiment storage and handling system for containers of different sizes.

FIG. 15 is an illustration of an example embodiment transfer channel (top and side view) with buffering bays at both ends.

FIG. 16 is an illustration of another example embodiment storage and handling system useable with sequential retrieval.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods may be executed repetitively, individually or sequentially, so as to provide looping or other series of operations. It should be presumed that any embodiment having features and functionality described below, in any workable combination, falls within the scope of example embodiments.

The inventors have recognized a need for handling solutions that make best use of scarce land while increasing throughput and efficiency. Fully or substantially automated processes may meet this need. Related art described in U.S. Pat. Nos. 7,785,056 to Sanford; 7,845,898 to Rawdon; and 7,972,102 to Ward, which are incorporated herein by reference in their entireties, address movement of containers from one point to another. All require human intervention throughout their processes, and thus do not provide adequately automated stacking and retrieval.

The inventors have recognized that existing automated systems for other technologies like personal automobiles may also be inapplicable. Co-owned international application PCT/IN2006/000344 (published Mar. 22, 2007 at WO/2007/032024), which is incorporated by reference herein in its entirety, describes an automated car parking system from a storage and retrieval point. This system includes a typical storage capacity for a tower with cars of around 200 storage spaces, which may be less than typical capacity required for container handling. This system may include a typical handling weight of around 1MT to 2MT, which may be less than typical weights between 2.5MT and 30MT for container handling. Further, a typical handling size for cars is about 5.5 m long, 2.2 m wide, and 1.6 m high, which may be different than typical dimensions for container handling of 14 m long, 2.6 m wide, and 2.8 m high. This system may use a platform carrier/pallet for cars that may require an equal number of platform carriers/pallets and storage spaces, which, while practical in a car parking situation with capacity of a few hundreds, may not work in a container handling system requiring thousands of pallets with greater handling complexity where such numbers pose operational challenges and may cause inefficiencies in container handling. This system's last mile connectivity for cars uses drive-in and drive-out of a storage tower that may be unavailable for containers requiring additional external transport devices for entry/exit from a tower.

The inventors have discovered that existing automated systems for related handling technologies may also be inapplicable. Co-owned international application PCT/IN2009/000137 (published Mar. 4, 2010 at WO/2010/023680), which is incorporated by reference herein in its entirety, describes a multi-level automated storage for over-dimensional or bulky objects. Following field trials on this system, the inventors discovered previously-unknown design problems with basic handling points, storage stability, last mile connectivity, and solution applicability in terms of reliability, safety, and cost. Specifically, the basic handling point in this system assumed that reinforcements at a container base were reliable, and handling equipment was designed to leverage the reinforcement members as a support while moving containers by pushing and pulling containers on rollers with support from the reinforcements. Field trials discovered that reinforcements were not reliable and often the most damaged and distorted parts of a container. As to stability in storage, each storage slot had a bed of rollers over which containers were placed such that containers were resting on rollers. This created a state of unstable equilibrium in which the system moved after small disturbances. If loading points are near the sea and/or at great heights, the probability of containers being disturbed due to wind forces, etc. is very high. For last mile connectivity, this system required containers to be placed in/taken out of elevators by means of external devices such as mobile cranes. Considering the storage arrangement, elevator cage dimensions and the reach of the cranes with respect to size of the containers, this arrangement could not meet the operational needs in terms of skill required, time, and automation. For reliability and safety, the design included many failure points, including a reinforcement member being used as support and bed of rollers as storage space.

The inventors have further recognized problems previously unknown in industry-standard handling systems for stacking and handling containers. For example, containers may be stacked in a stack yard on the ground one-over-another up to 6 containers high and one-beside-another up to 6 rows of containers deep using Rubber Tired Gantry (RTG) and/or Rail Mounted Gantry (RMG) cranes. This practice may, however, limit stacking heights due to inherent design and height requirements of cranes and limit operational flexibility due to design limitations of refrigerated containers. Further, containers in such a system cannot be randomly accessed, which may require multiple unproductive handlings at times that adversely affect operation efficiency, throughput, and logistics control.

The inventors have recognized that handling containers from a ship to a container yard may benefit from additional efficiency like full or substantially full automation. Typically, containers are unloaded from ships and may be placed on berths. Movement from berth to stack yard and vice versa can be handled by saddle cranes, Automated Guided Vehicles (AGVs), and/or a combination of trucks and mobile cranes. The inventors have recognized that, while standard, these practices occupy much land, and the equipment deployed is capital- and labor-intensive, impacting operational efficiency.

The inventors have recognized that existing systems may lack real-time visibility and thus track-and-trace functionality for specific container locations within container terminals. Relying on a single costly piece of equipment, such as a RTG or RMG crane, to move a container in X, Y, and Z planes during loading and unloading in a single chain of operation results in reduced throughput and underutilization of capital equipment. Such systems are further of limited compatibility with modern security measures like fire detection and protection and surveillance

The inventors have recognized that removing any or all of the above newly-identified shortcomings may provide more efficient, safe, and cost-effective handling of containers and other bulky objects, such as with an integrated system using substantially complete automation, with higher space and equipment utilization, wider applicability to different types of handling and storage, higher durability, lower risk of loss, and better compatibility with safety and monitoring systems. The disclosure below enables unique solutions to these issues and other issues identified by the inventors.

The present invention is an automated storage and retrieval system for a storage facility and containers using a transfer subsystem or assemblies between storage and destination/source. Example embodiments discussed below illustrate just a couple of the variety of different configurations that can be used in connection with the present invention.

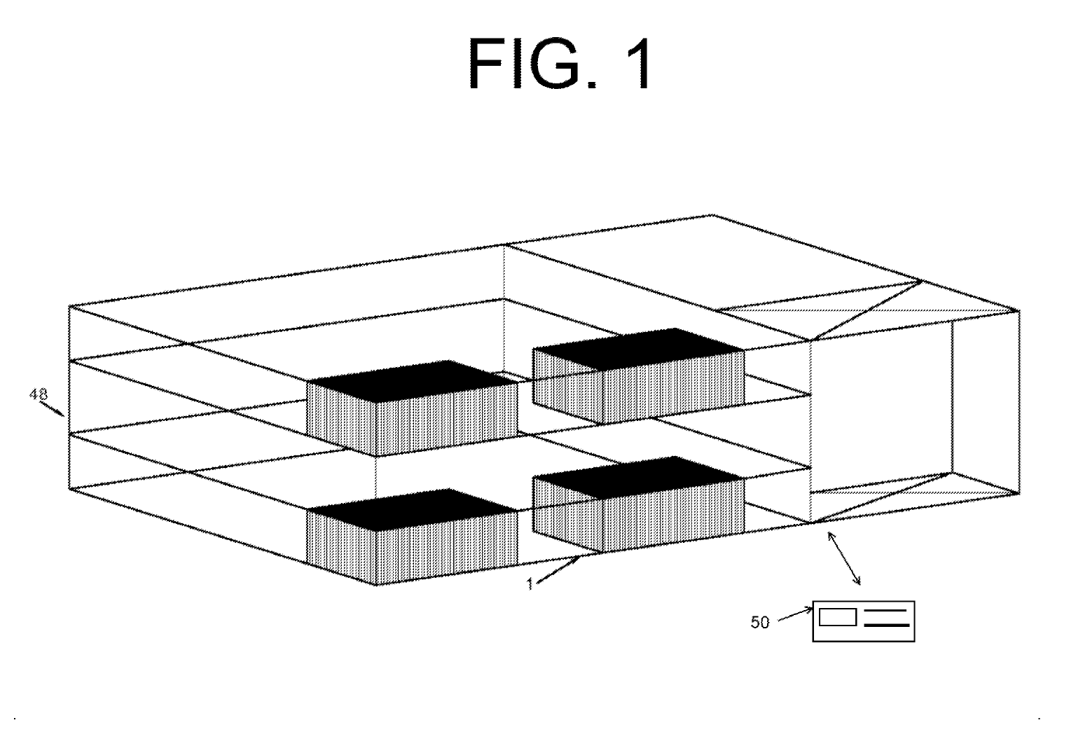

FIGS. 1-11 are illustrations of an example embodiment handling system. The example system of FIGS. 1-11 may be integrated end-to-end so as to allow automated handling of containers and other bulky objects. The example system of FIGS. 1-11 is useable with container handling in container terminals from unloading areas to a final delivery area and may include specialized example embodiment components for movement and multi-level stacking of containers. For example, the system of FIGS. 1-11 may be useable with and contain components integrated for: unloading from trucks and other vehicles; handling containers at a receipt location, multi-level stacking of containers; selective or sequential retrieval of individual or plural containers, handling containers for delivery, and/or loading containers onto trucks or other vehicles. The example embodiment may thus enhance global supply chain logistics effectiveness by offering higher space utilization factors, higher efficiency in operations, logistics control—including real time visibility for track and trace of containers—and higher throughput in container terminals and storage yards.

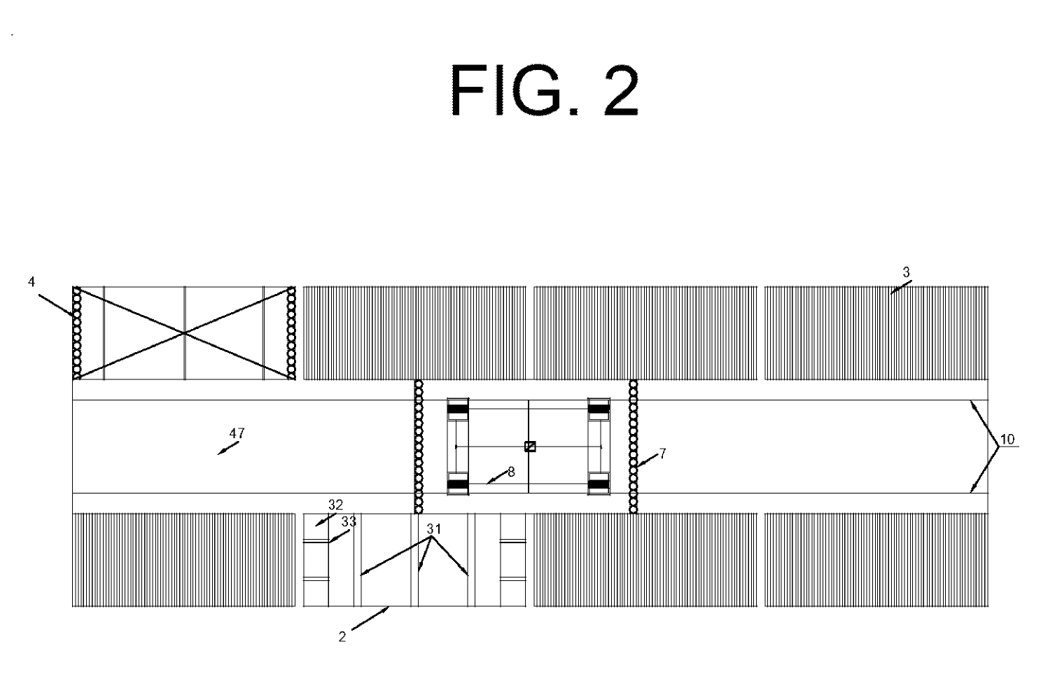

The example embodiment handling system of FIGS. 1-11 include or work with three sub-systems: a storage subsystem, a transfer subsystem, and/or a central system controller. As shown in FIG. 1, example embodiment systems may include or work in a storage subsystem including a storage tower 48. For example, storage tower 48 may be a steel or reinforced concrete tower that houses stacked containers 3 (FIG. 2) and components of the storage subsystem. Storage tower 48 may have a number of tiers 1 for multi-level storage with a central causeway 47 (FIG. 2) in each tier 1 and addressed storage slots 2 that are marked storage locations for containers 3 in each tier 1 on sides of central causeway 47.

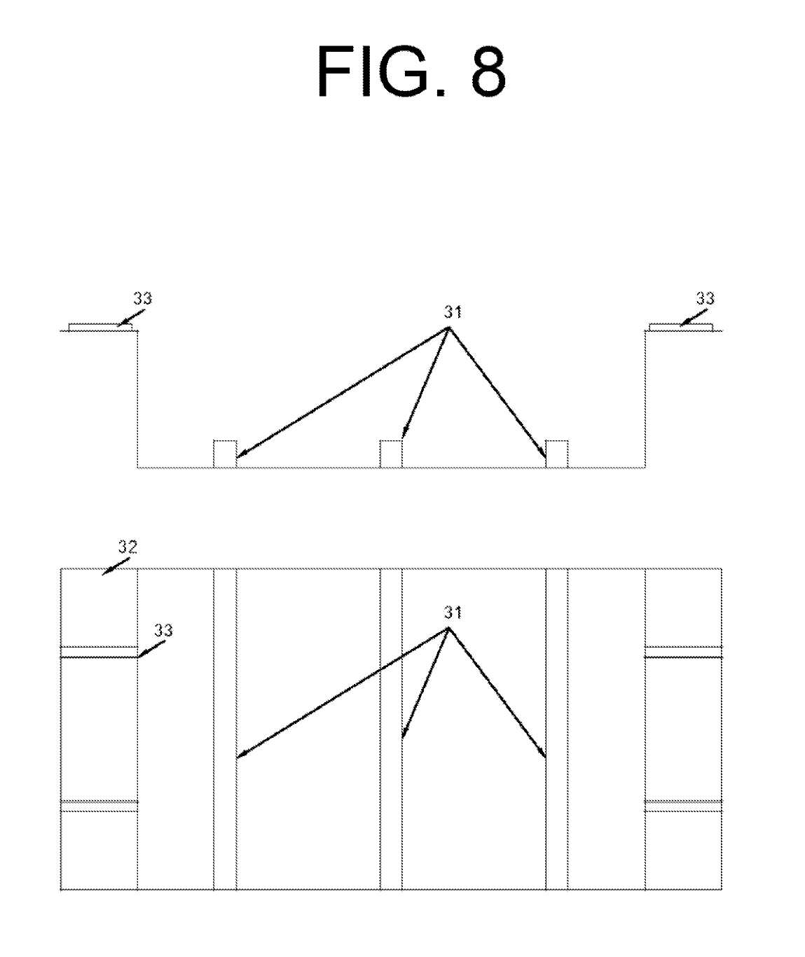

As shown in FIG. 2, each tier 1 has a number of levels. For example, a lower level may be at a middle of a tier 1 with a central causeway 47 with fixed first tracks 10 for travel of transfer module assembly 7. Transfer module assembly 7 may carry container 3 along a line of storage (lengthwise in FIG. 2). An upper level on both sides of central causeway 47 may serve as a base for addressed storage slots 2 on a storage level. Addressed storage slots 2 (also shown in FIG. 8) may have two levels at their base, the first being an upper level for storage at both sides and transverse to the line of storage. This arrangement of the upper level may firmly support containers 3 on their cast corner legs when stacked. The second level may be a lower level at a middle with fixed third tracks 31 for travel of transfer arm assembly 8 to carry container 3 transverse to the line of storage. Stoppers 33 (FIG. 8) may be strips of steel flats, for example, fixed on a rear end of a front corner leg support point and front end of rear corner leg support point to prevent sliding of containers 3.

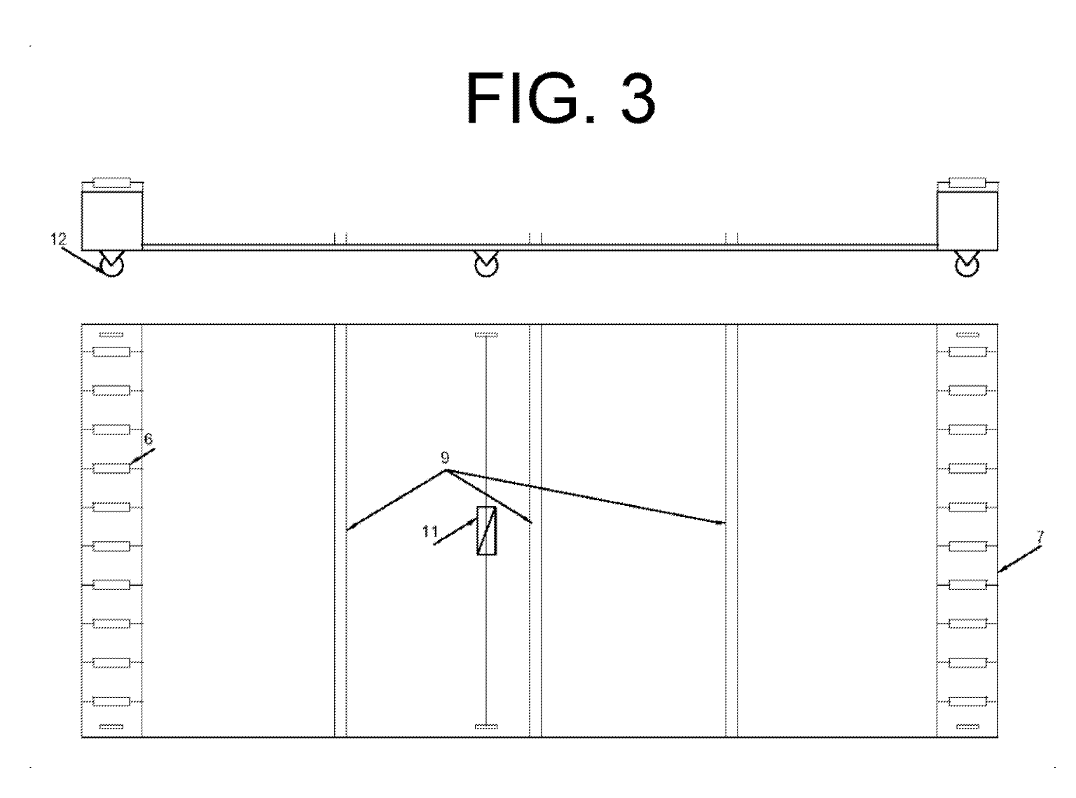

A storage subsystem may further include an example embodiment transfer module assembly 7. There may be one or more transfer module assemblies 7 per tier 1. As shown in FIG. 3, example embodiment transfer module assembly 7 may include a steel or other rigid structure frame, wheels 12, and/or an independent drive arrangement 11 mounted on or otherwise secured to the frame to move assembly 7 along fixed first track 10 (FIG. 2), on central causeway 47 (FIG. 3), both in forward and reverse directions.

Transfer module assembly 7 may include two levels. A first level may be an upper level for storage having movement-facilitation devices like balls, belts, or rollers 6 on top in rows transverse to the line of storage and of width to meet and support cast corner legs of containers 3 and to carry container 3. A second level may be a lower level at a middle position with a fixed second track 9 transverse to the line of storage. Transfer module assembly 7 may thus include an upper level in line with an upper level of addressed storage slot 2 (FIGS. 2/8) for storage and a fixed second track 9 in line with fixed third track 31 (FIG. 2) of addressed storage slot 2 on a third track level. These alignments may facilitate transfer of container 3 (FIG. 2) from transfer module assembly 7 to addressed storage slot 2 and vice versa.

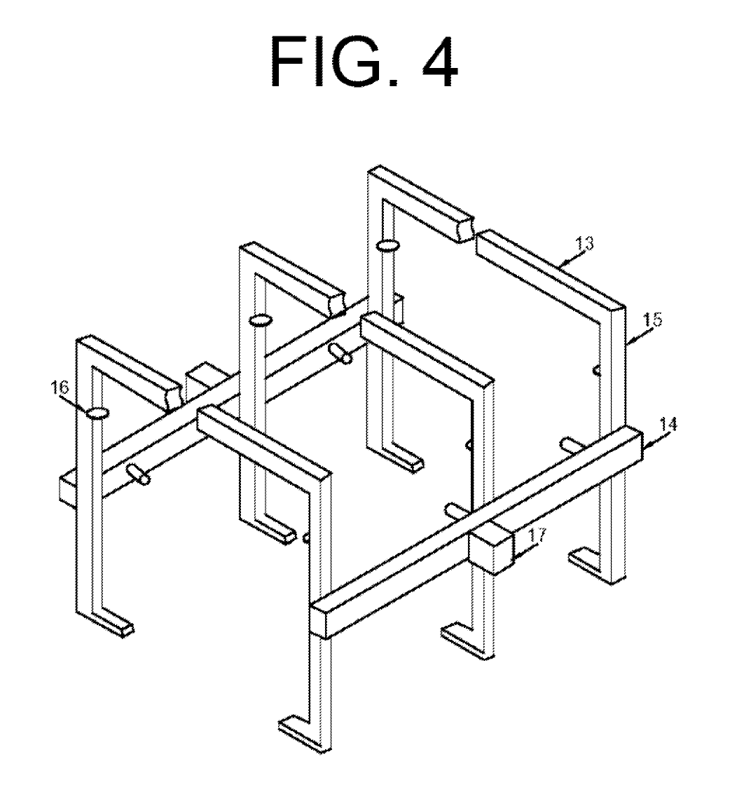

As shown in FIG. 4, transfer module assembly 7 may include side structures 13 at one or both ends transverse to the line of storage. Vertical members 15 of side structures 13 may be fitted with guide wheels 16 to guide movement of containers 3 (FIG. 2) without skewing when transferred from/to assembly 7. Components of transfer module assembly 7 may include remotely-controlled hold and/or release devices 17. Hold and/or release devices 17 may be mounted on or fixed with horizontal members 14 of side structures 13, for example. Holding devices 17 may hold containers 3 securely when container 3 is moved laterally along the line of storage on transfer module assembly 7.

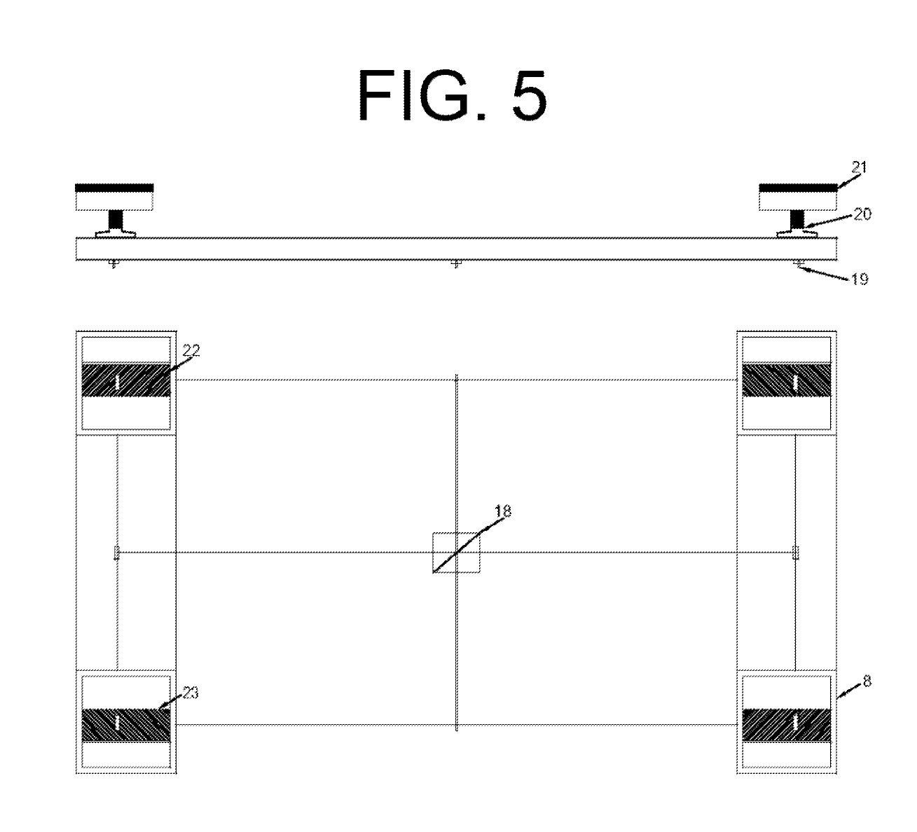

Transfer module assembly 7 may include an example embodiment transfer arm 8 (FIG. 2). For example, as shown in FIG. 5, transfer arm 8 may include a steel or other rigid structure frame, wheels 19, and/or a separate drive 18 that may be secured to arm 8 to move arm 8 along fixed second track 9 (FIG. 3) and third track 31 (FIG. 2) both in forward and reverse directions and transversely to the line of storage. Transfer arm 8 may include two or more lifting devices 20 positioned where container 3 would be supported when mounted thereon. For example, lifting devices 20 may be powered by electrical, mechanical, magnetic, and/or pneumatic drives or other motivating devices. Lifting devices 20 may be coordinated to provide for uniform lifting.

Transfer arm 8 may be configured and positioned so that lifting devices 20 in a lower disposition move unhindered under containers 3 on transfer module assembly 7 (FIG. 3) or in addressed storage slot 2. Transfer arm 8 in a lifted position may support containers 3 while moving along tracks to transfer containers 3 from transfer module assembly 7 to addressed storage slot 2 and vice versa. Arms 8 at supporting points may include a holding clamp 22 with frictional pads 23 to hold container 3 by a side bottom channel member firmly and securely. Of course, other holding and securing devices may also be used with transfer arm 8.

As shown in FIG. 2, one or more example embodiment elevator assemblies 4 may be oriented and installed along the line of addressed storage slots 2. Elevators 4 may include shafts that extend through several floors or tiers 1, and elevators 4 may vertically move among and open to the various floors. Elevators 4 may include a cage with openings on both opposite sides along the line of storage. Elevator 4 may have a number of levels, such as two levels at its base. An upper level may be transverse to the line of storage, with a width slightly more than the cast corner legs of containers 3.

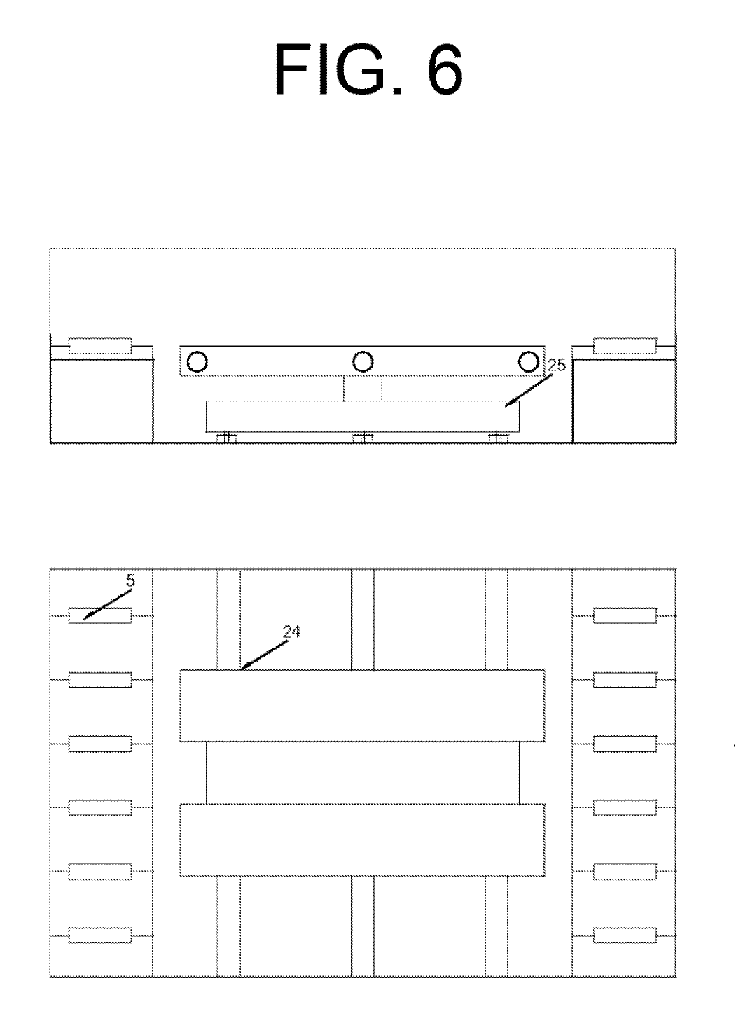

As shown in FIG. 6, an elevator may be mounted or otherwise equipped with lower-friction movement devices such as rows of balls or rollers 5 on an upper level. The upper level with rollers 5 can match transfer module assembly 7 (FIG. 2) top level for storage. A lower level at a middle position of elevator 4 may carry fixed fourth tracks 24.

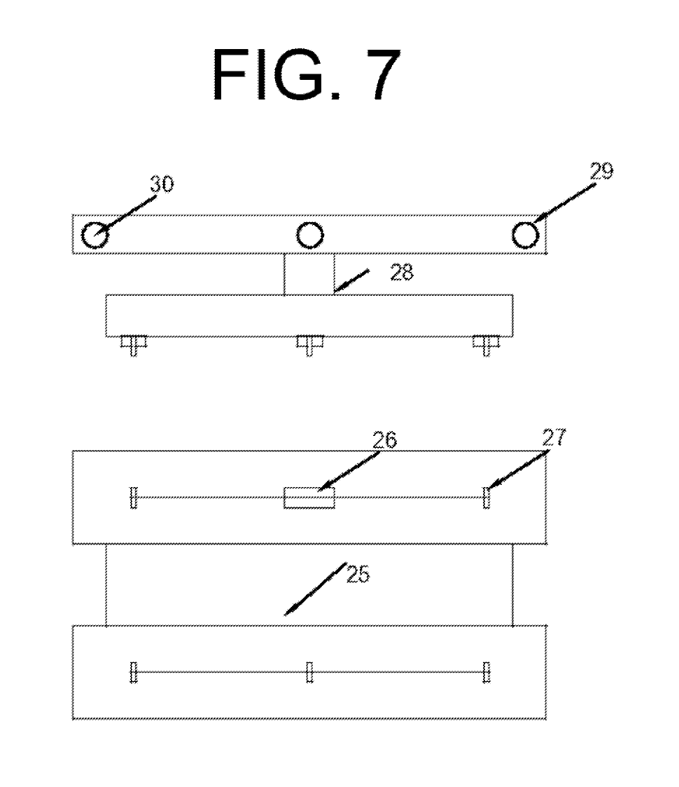

As shown in FIG. 7, an elevator may include an example embodiment elevator power arm 25, which may include a steel structure frame, wheels 27, and/or a drive 26 mounted or secured on arm 25 to move arm 25 along fixed fourth track 24 (FIG. 6) in forward and reverse directions so as to move containers 3 in and out of elevator 4 (FIG. 2). Elevator power arm 25 may include a lifting device 28 near a center. Lifting device 28 may be powered by an electrical, mechanical, magnetic, pneumatic, and/or other motivating type of drive. In a lowered position, elevator power arm 25 can move completely underneath containers 3 in position in elevator 4, from one end of elevator 4 to the other without disturbing containers 3. Elevator power arm 25 may be configured to position itself at any end of container 3 to move container 3 from either side.

Lifting device 28 may include a fixed bottom mounted on or secured to the elevator and a vertically extending member at its top. The extending member may include fixed contact arms 29 at a top on both sides transverse to the line of storage. Contact arms 29 may be sufficiently long to provide uniform pressure on container 3 for moving and wide enough to make contact with all sizes of containers 3. Contact arms 29 can also include additional securing/moving devices, such as one or more remotely-controlled electromagnets 30 near a center to ensure additional force and security during pushing and move container 3 during pulling.

FIG. 8 is a top and sectional view of an example embodiment addressed storage slot 2, showing supporting points 32 and fixed third track 31 for transfer arm movement. As shown in FIG. 8, stoppers 33 may be arresting strips arranged on supports 32 on either side of fixed third track 31 in addressed storage slot 2, which may provide support for containers 3 without sliding or other incidental movement when containers 3 are deposited or removed from addressed storage slot 2.

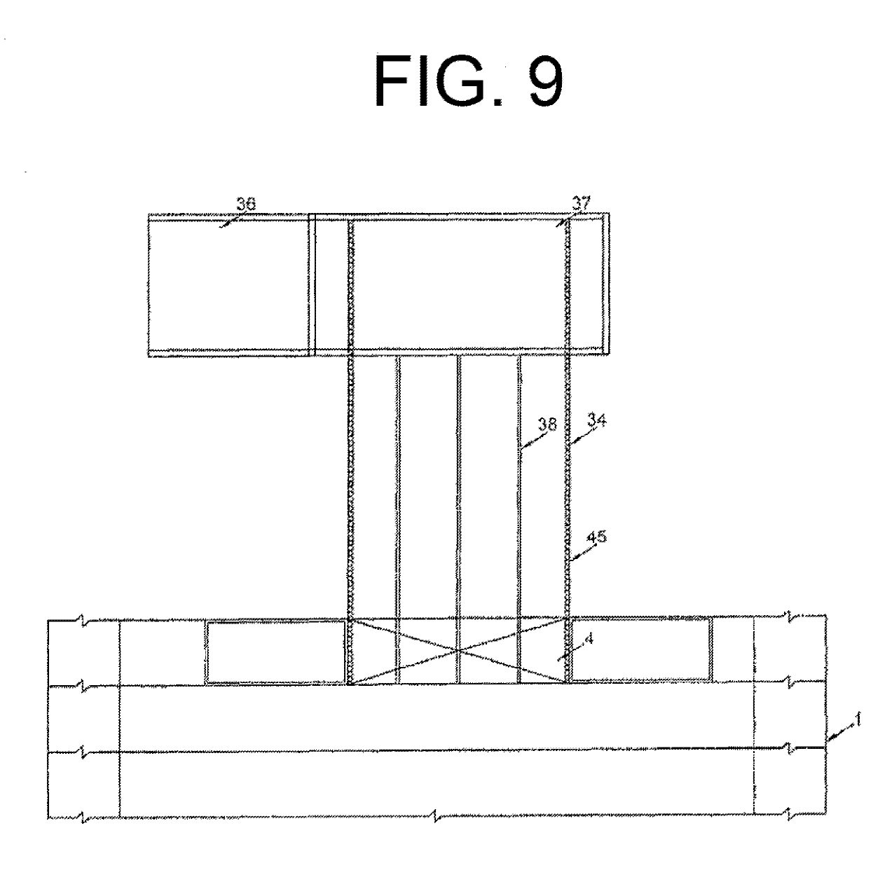

Example embodiment handling systems may further include an example embodiment transfer subsystem. A transfer subsystem may include elevator 4 to provide space for containers 3 to be transferred between various areas. For example, as shown in FIG. 9, containers 3 may be transferred from an unloading area 37 to the storage subsystem and vice versa. Such transfer may include unloading containers 3 from a truck or other providing vehicle or source, moving containers 3 to the storage subsystem, receiving containers 3 from the storage subsystem and loading containers 3 onto the trucks or other destination for delivery. Area 37 is oriented in FIG. 9 at an outer side of elevator 4 and transverse to the line of storage.

As shown in FIG. 9, example embodiment buffering bay assembly 45 may serve in a transfer subsystem as a storage buffer between the unloading/loading operations and stacking/retrieval operations of the storage subsystem in the example embodiment system to provide margins between the possible differences in their operating speeds. Buffering bay assembly 45 may have a flexible capacity sufficient to meet operational requirements of any storage, handling, or retrieval project.

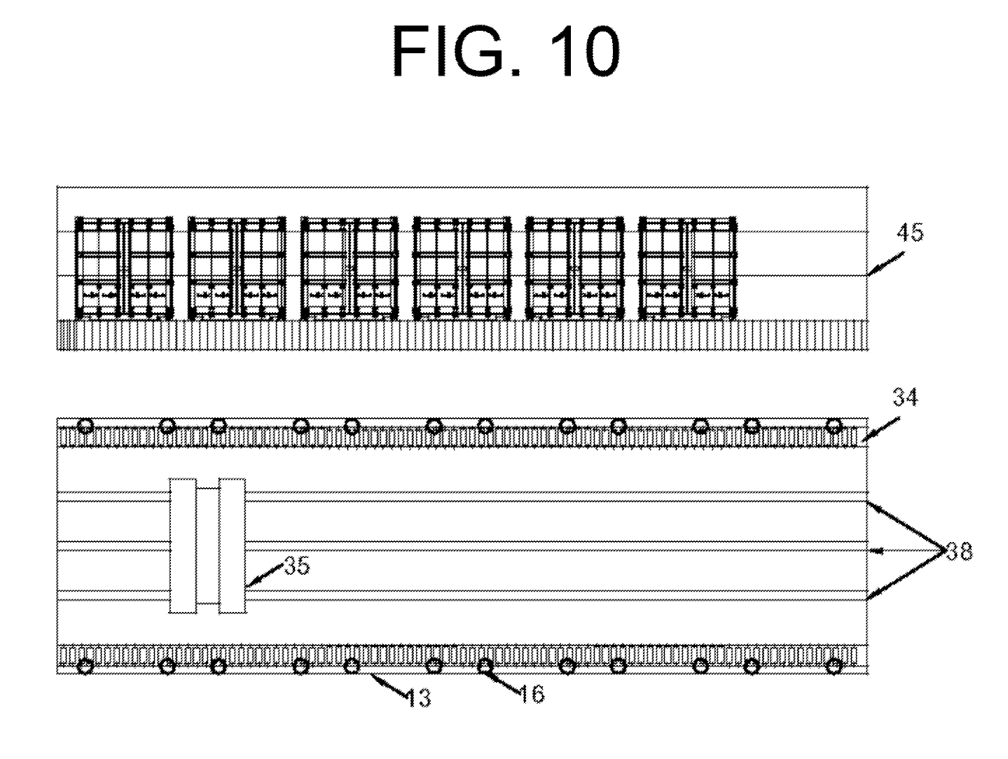

As shown in FIG. 10, example embodiment buffering bay assembly 45 may include levels similar to and compatible with previously-described levels. For example, buffering bay assembly 45 may include an upper level having length and width sufficient to handle containers 3 through support rollers supporting cast corner legs of container 3. A lower level may be at a middle with a fixed fifth track 38. Side structures 13 with guide rollers 16 may be on sides of buffering bay assembly 45 for controlled and easy movement of containers 3 without skewing. One or more support rollers and/or guide rollers may include drives to help move containers 3 along buffering bay assembly 45.

Buffering bay assemblies 45 may include at least one buffering bay power arm 35 like example embodiment elevator power arm 25 (FIG. 7) having a steel or other rigid structure frame, wheels 27 (FIG. 7), and/or a drive 26 (FIG. 7) to provide movement along fixed fifth track 38 both in forward and reverse directions. Buffering bay power arm 35 may also include any or all features of elevator power arm 25 in order to fit under and move containers 3 from one end of bay assembly 45 to another, such power arm features being labelled and used interchangeably.

As shown in FIGS. 9 & 11, container loading/unloading area 37 and transfer equipment 39 may make up an example embodiment transfer station positioned next to and in line with buffering bay assembly 45. A transfer station may be considered a continuation of buffering bay 45 but without side structures 13 and/or track 38. In loading/unloading area 37, transfer equipment 39 may unload containers 3 out of a truck or other vehicle or source and feed into buffering bay assembly 45 for further handling. Area 37 may be level with a top level of bay 45 and include rows of balls and/or rollers or other movement-facilitation devices to allow free movement in both directions, including free movement of containers 3 along unloading/loading area 37 and free movement of trucks or other vehicles across unloading/loading area 37.

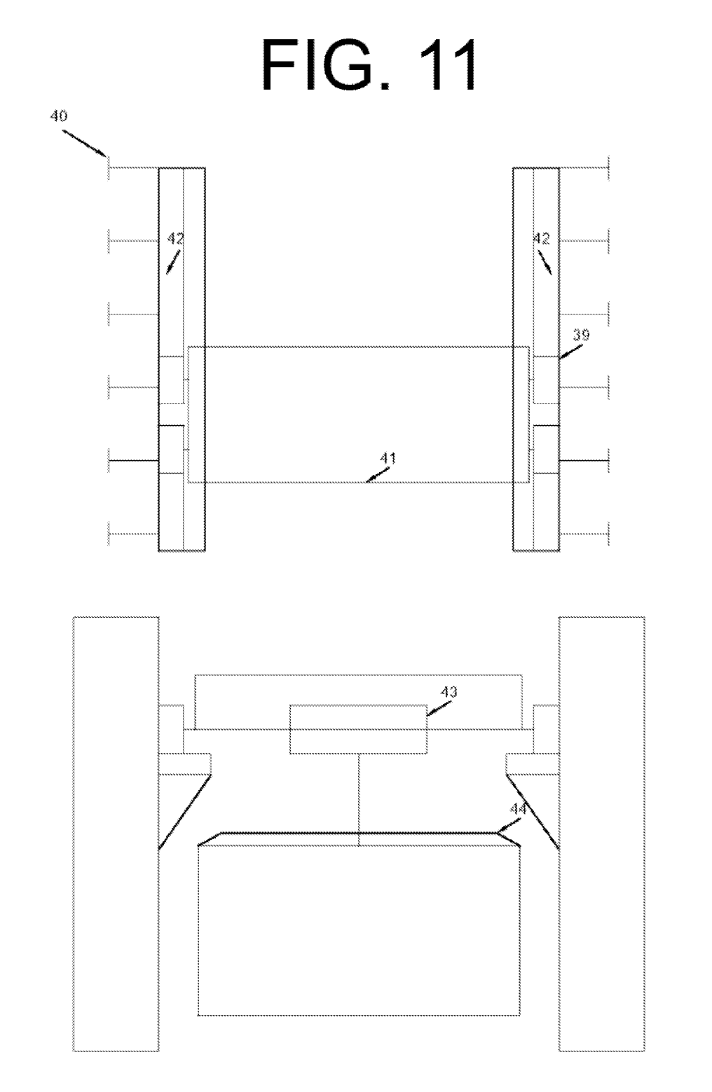

As shown in FIG. 11, one or more pieces of transfer equipment 39 may unload/load containers 3 from/to a vehicle. For example, transfer equipment 39 may include a framed structure with a number of columns 40, supporting a travelling gantry 41 with drives mounted or secured thereon. Such drives may be configured to move gantry 41 in forward and reverse directions on gantry tracks 42 provided on columns 40. Gantry 41 may include a lift that lifts and/or lowers a lifting tackle 43 to a standard spreader 44.

Loading/unloading area 37 may be separated into distinct loading and unloading sections where operational/safety requirements demand a separate loading area. Vehicles or other container sources/destinations may be moved past unloading area 37 and positioned at a designated loading area 36 a desired distance from unloading area 37. Once positioned in loading area 36, container 3 is moveable to unloading area 37 from buffering bay assembly 45 with buffering bay power arm 35. Travelling gantry 41 may lift container 3 from unloading area 37 and move on fixed tracks 42 to loading area 36 to load containers 3 on to a vehicle or other destination.

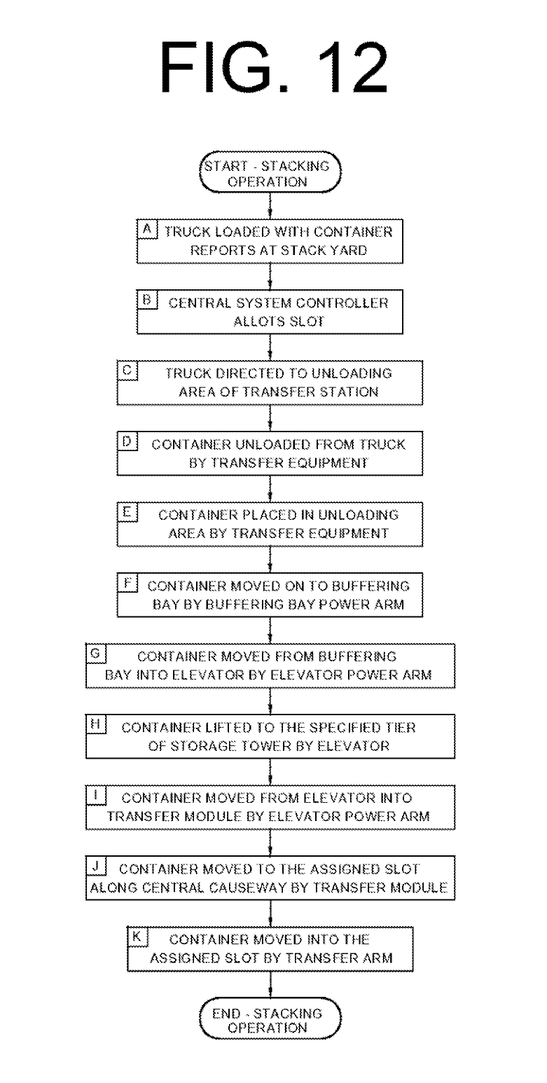

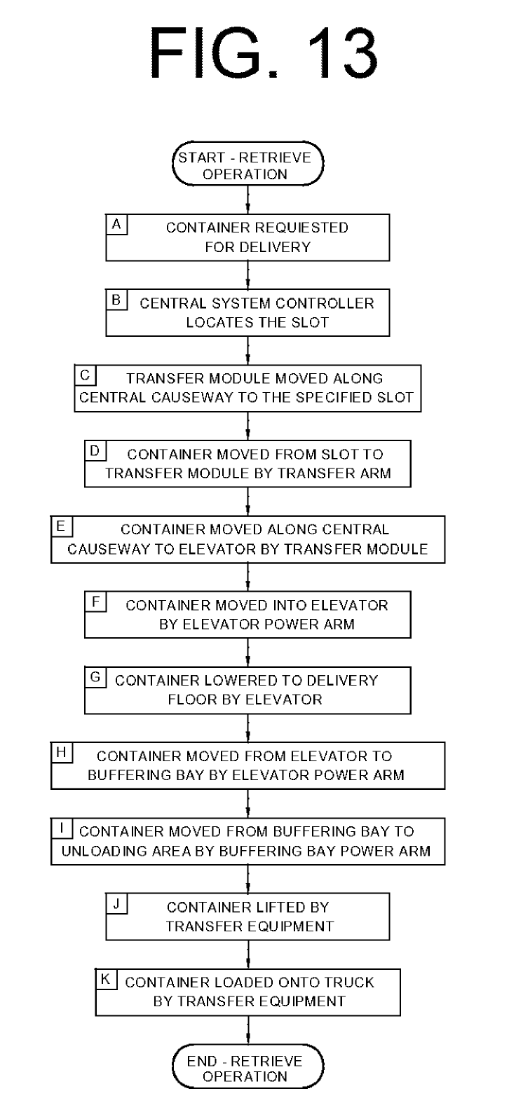

Example embodiment handling systems may further include a central system controller 50 positioned anywhere and communicatively connected among various subsystems and components. Central system controller 50 can command, control, monitor, and/or co-ordinate among all the subsystems, including a storage subsystem, a transfer subsystem, and/or a human-machine interface for operating personnel. Central system controller 50 can include hardware like programmable logic controllers, micro controllers or equivalents, control panels, human-machine interface, control cabling, sensors, drives, etc. as well as software to enable all components of example embodiment handling systems to integrate seamlessly and cooperate for operational efficiency, reliability and safety. For example, central system controller 50 may be specifically configured with the algorithms of example methods shown in FIGS. 12 and 13.

An example system being described with various configurations and options, example methods that work with example systems are now described. Although example methods are uniquely usable with example systems and described in connection with elements labelled in FIGS. 1-11, other systems can be used with example methods, and vice versa.

FIG. 12 is a flow chart detailing stacking operations in an example handling method. The operations of FIG. 12 may each be executed and controlled by a central system controller 50 in communicative connection with various system components. The operations of FIG. 12 are further useable with containers 3 of example embodiments of varying dimensions and characteristics. As shown in FIG. 12, in A, a truck or other vehicle delivering one or more containers may report to a stack yard or other facility for container storage and/or handling. In B, the central system controller can register the arrival and allot a space for the delivered containers. In C, the truck or other source may be directed to unloading area 37 at the transfer station.

In D, the containers may be unloaded by transfer equipment 39; for example, lifting tackle 43 may be lowered to connect to or grab a container with spreader 44. In this way, transfer equipment 39 may lift containers and free any vehicle or other source to exit unloading area 37. In E, the container is placed in unloading area 37 by transfer equipment 39; for example, lifting tackle 43 may lower and place the container on rollers or other transport pallets at a base of unloading area 37.

In F, the container may be moved onto buffering bay 45 by buffering bay power arm 35. For example, power arm 35 in buffering bay 45 may move on fixed fifth track 38 toward unloading area 37 and stop near the container at a position determined by the central system controller. Lifting device 28 of power arm 35 can raise to make contact with the container through contact arm 29. Electromagnet 30 may be energized to secure such contact. Power arm 35 may move along fixed fifth track 38 of the buffering bay 45 in the reverse direction, moving the container along on rollers 34 to near elevator 4 as determined by the central system controller. Electromagnet 30 may be de-energized to release the container. Lifting device 28 may be lowered and the buffering bay power arm 35 may return to the other end of the buffering bay 35 near unloading area 37 to handle other containers.

In G, the container may be moved from buffering bay 35 into elevator 4 by elevator power arm 25 in elevator 4 moving on fixed fourth track 24 toward buffering bay 35 and stopping at elevator 4 as determined by the central system controller. Lifting device 28 of power arm 25 can raise to make contact with the container through contact arm 29. Electromagnet 30 may be energized to secure the contact. Power arm 25 may move along fixed fourth track 24 of elevator 4 in the reverse direction, moving the container along on rollers 5 until placed inside elevator 4 as determined by the central system controller. Electromagnet 30 may be de-energized to release the container. Lifting device 28 may be lowered and elevator power arm 25 can returns to near a center of elevator 4. In H, the container may be lifted to a desired or assigned tier (from B) of a storage tower by elevator 4 as determined by the central system controller.

In I, the container may be moved from elevator 4 into transfer module assembly 7 by elevator power arm 25. For example, elevator 4 can move on fixed fourth track 24 and stop at an end of the elevator as determined by the central system controller. Lifting device 28 of power arm 25 may raise to make contact with the container through contact arm 29. Electromagnet 30 may be energized to secure the contact. Power arm 25 may move along fixed fourth track 24 of elevator 4 in the reverse direction, moving or pushing the container along on rollers 5 and placing the container on transfer module assembly 7 as determined by the central system controller. Electromagnet 30 may be de-energized to release the container. Lifting device 28 may be lowered and elevator 4 may return to near a center of elevator 4. As the container is transferred, guide rollers 16 on vertical members 15 can guide movement of the container without skewing. When the container is fully transferred to the transfer module assembly 7, holding device 17 on side structures 13 may be energized to hold the container in position.

In J, the container may be moved to assigned slot 2 along central causeway 47 by transfer module assembly 7. For example, transfer module 7 may move with the container to a desired addressed storage slot 2 along central causeway 47. The container may be firmly secured in position by holding device 17. When the container reaches a desired position, such as in front of a desired slot 2 determined by the central system controller, holding device 17 may be de-energized so as to release the container.

In K, the container may be moved into an assigned slot 2 by transfer arm 8. For example, transfer arm 8 may be activated, and lifting and supporting device 20 may be activated to lift the container off transfer module assembly 7 with holding clamp 22 and frictional pads 23. Transfer arm 8 may move through its drive 18 along fixed second track 9 in transfer module assembly 7 and fixed third track 31 on addressed storage slot 2. When the container is moved to a position determined by the central system controller, lifting and supporting device 20 of transfer arm 8 can lower so that the container rests on supports 32. Arresting strips 33 on support 32 may ensure container is held in position. Transfer arm 8 may return on its path in the reverse direction along fixed third tracks 31 and second tracks 9 and return to a home position. When transfer arm 8 returns to a home position, transfer module assembly 7 may move along central causeway 47 to a home position. Any of actions A-K may then be repeated, currently and/or repeatedly in order to move any number of containers.

FIG. 13 is a flow chart detailing retrieval operations in an example handling method. The operations of FIG. 13 may each be executed and controlled by central system controller 50 in communicative connection with various system components. The operations of FIG. 13 are further useable with containers 3 of example embodiments of varying dimensions and characteristics. In A, a container is requested for delivery, perhaps by a vehicle arriving at the facility or an owner or purchaser. In B, the central system controller can locate addressed storage slot 2 that houses the requested container. In C, transfer module assembly 7 may move along central causeway 47 to addresses storage slot 2 as determined by the central system controller.

In D, transfer arm 8 may move the container from slot 2 to transfer module assembly 7. For example, transfer arm 8 may be activated and move along fixed second track 9 in transfer module assembly 7 and along the fixed third track 31 in addressed storage slot 2 until reaching a point determined by the central system controller. On reaching the point, lifting and supporting device 20 may be activated and the container may be lifted off storage slot 2 with holding clamp 22 and frictional pads 23. Transfer arm 8 may move under the power of drive 18 along fixed third track 31 in addressed storage slot 2 and fixed second track 9 in transfer module 7. When the container is moved to a position determined by the central system controller, lifting and supporting device 20 of transfer arm assembly 8 may lower so that the container rests on transfer module 7. As the container is transferred, guide rollers 16 on vertical members 15 may guide movement of container without skewing. When the container is fully transferred to transfer module 7, holding device 17 on side structures 13 may be energized to hold the container in position.

In E, the container may be moved along central causeway 47 to elevator 4 via transfer module 7. For example, transfer module 7 can move to elevator 4 along central causeway 47 until reaching a point determined by the central system controller in front of the elevator. Then holding device 17 may be de-energized to release the container. In parallel, elevator 4 may reach a desired tier 1 to receive the container from transfer module 7.

In F, the container may be moved into elevator 4 by elevator power arm 25. For example, power arm 25 in elevator 4 may move on fixed fourth track 24 toward transfer module 7 and stop at an end of elevator 4 as determined by the central system controller. Lifting device 28 of power arm 25 can raise to make contact with the container through contact arm 29. Electromagnet 30 may be energized to secure the contact. Power arm 25 may move along fixed fourth track 24 of the elevator 4 in the reverse direction, moving the container along rollers 5 to place the container inside elevator 4 at a position determined by the central system controller. Electromagnet 30 may be de-energized to release the container. Lifting device 28 may be lowered, and elevator 4 can return to near a center of elevator 4. As the container is transferred from transfer module 7 to elevator 4, guide rollers 16 on vertical members 15 may guide the movement of container to prevent skewing and achieve desired travel.

In G, container can be lowered to delivery floor 37 by elevator 4. For example, the container may be lowered to a delivery tier 1 of a storage tower by elevator 4 as determined by the central system controller.

In H, the container may be moved from elevator 4 to buffering bay 45 by elevator power arm 25. For example, power arm 25 in elevator 4 can move on fixed fourth track 24 toward transfer module 7 and stops at an end of elevator 4 as determined by the central system controller. Lifting device 28 of power arm 25 may raise to make contact with the container through contact arm 29. Electromagnet 30 may be energized to secure the contact. Power arm 25 may move along fixed fourth track 24 of elevator 4 in the reverse direction, moving the container along on rollers 5 until placed on buffering bay 45 as determined by the central system controller. Electromagnet 30 may be de-energized to release the container. Lifting device 28 may be lowered and elevator 4 can return to near a center of elevator 4. As the container is transferred, guide rollers 16 on vertical members 15 of buffering bay 45 may guide the movement of container in a desired direction to prevent skewing.

In I, the container may be moved from buffering bay 45 to loading area 37 by buffering bay power arm 35. For example, power arm 35 in buffering bay 45 may move on fixed fifth track 38 toward elevator 4 and stop near the container as determined by the central system controller. Lifting device 28 of power arm 35 may raise to make contact with the container through contact arm 29. Electromagnet 30 may be energized to secure the contact. Power arm 25 can move along fixed fifth track 38 of buffering bay 45 in the reverse direction, pushing the container along rollers 34 until placed in loading area 37 as determined by the central system controller. Electromagnet 30 may be de-energized to release the container. Lifting device 28 may then be lowered.

In J, the container is lifted by transfer equipment. For example, transfer equipment 39 may lower lifting tackle 43 and grab the container by spreader 44. Transfer equipment 39 may thus lift the container from loading area 37 to load the container onto a truck or other destination. In K, the container is loaded onto a destination by transfer equipment. For example, a truck can be positioned beneath the container in the lifted position in loading area 37, and lifting tackle 43 may lower and place the container on the truck.

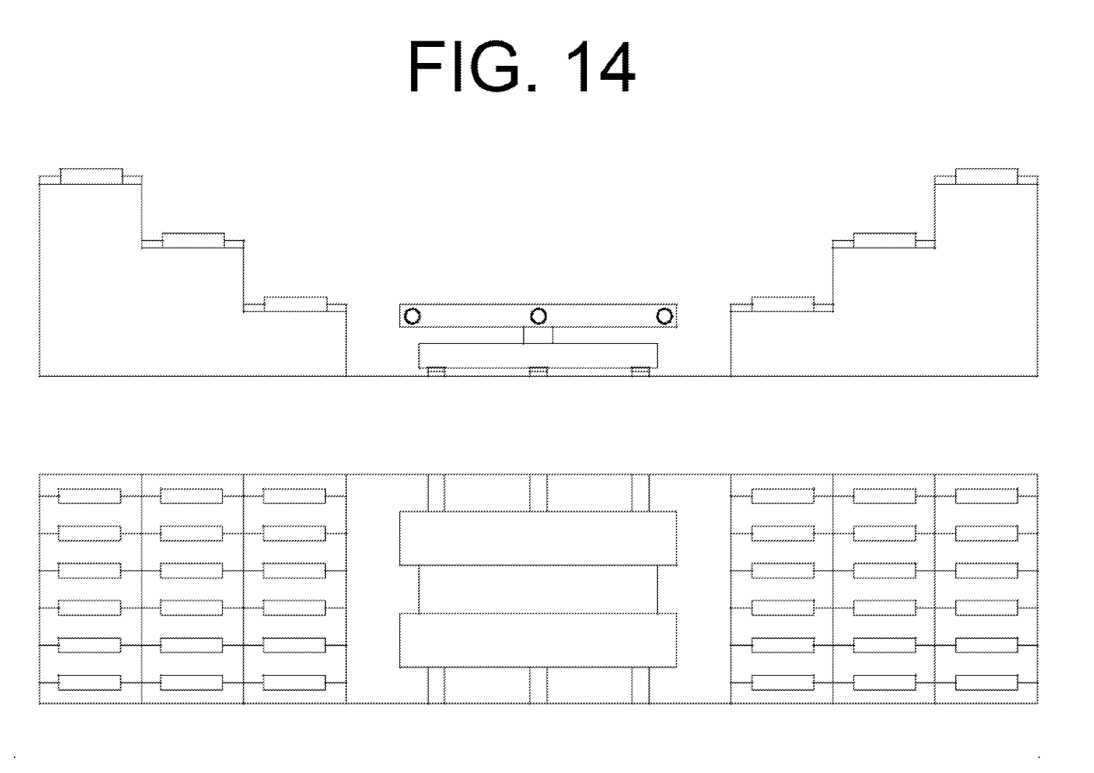

FIG. 14 is an illustration of another example embodiment handling and storage system useable with example methods and having components with a same name and functionality as those previously described. For example, sometimes a smaller container yard will include a single storage tower to stack containers of different sizes. In a single storage tower, each tier may be designed to handle containers of a specific size. In this example, a transfer module assembly with its transfer arm assembly in each tier can be configured for the specific container size corresponding to that tier. A common handling facility, such as an elevator assembly, and transfer system including a buffering bay assembly and transfer station can be designed to handle all containers with the changes in the base through a stepped structure design as shown in FIG. 14 with each step designed to hold container of a specific size. An extending member in a lifting device at a power arm center, for both an elevator power arm and a buffering bay power arm, can be shaped and configured to extend so as to accommodate containers of all sizes.

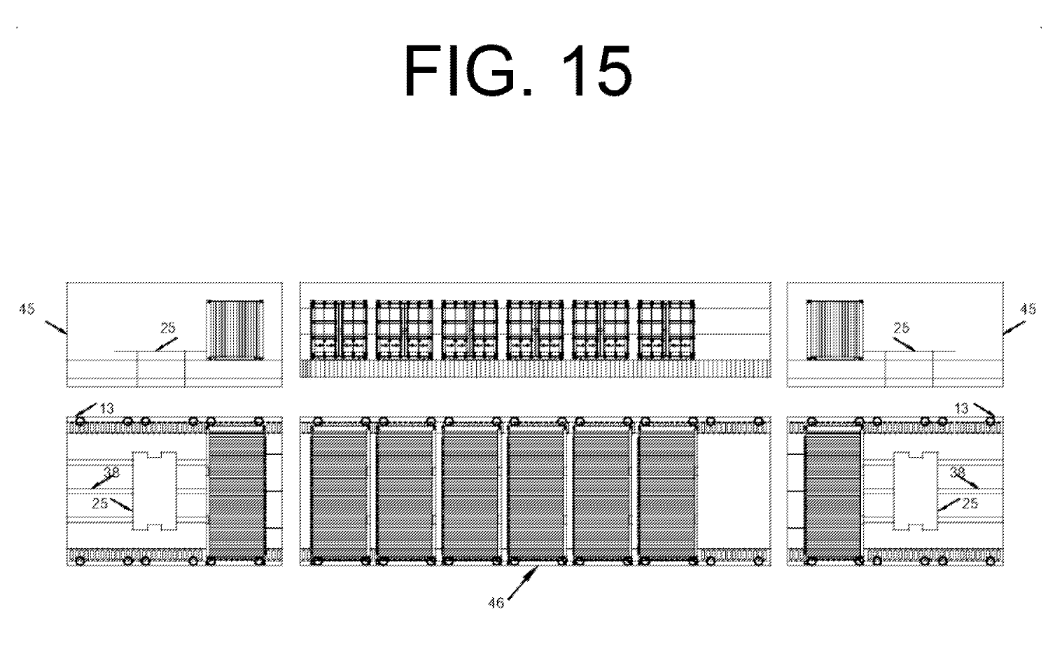

FIG. 15 is an illustration of another example embodiment handling and storage system that automates container movement from ship to storage yard with a transfer channel and buffering bay assemblies at both ends, for example, at a ship end and storage tower end. In FIG. 15, transfer channel 46 is a strong structure, such as a structure fabricated from reinforced concrete or steel, installed at ground or at any elevation. Transfer channel 46 may be built on columns over pile foundations, for example. Transfer channel 46 may connect two buffering bays 45, one at ship end and the other at storage tower end.

Transfer channel 46 and buffering bay assemblies 45 may be at a same elevation. A width of transfer channel 46 may hold containers lengthwise. Rollers, equally spaced, may be provided on sides of a base to support the containers through corner cast legs. Supporting structures 13 may be positioned along a length on these sides, and guide rollers may be mounted on or secured to vertical members of side structures to ensure movement of containers without skewing. Containers can be moved through a drive imparted through one or more supporting rollers at the bottom or through one or more guide rollers at the vertical members attached to the side structures. Platforms may be provided on sides of transfer channel 46 to provide access for repair and maintenance. Buffering bay assemblies 45 may be similar to those described in connection with the example embodiment of FIGS. 1-11. The example embodiment of FIG. 15 may be extended to driving of piles into the sea and an installation of a transfer channel in the sea.

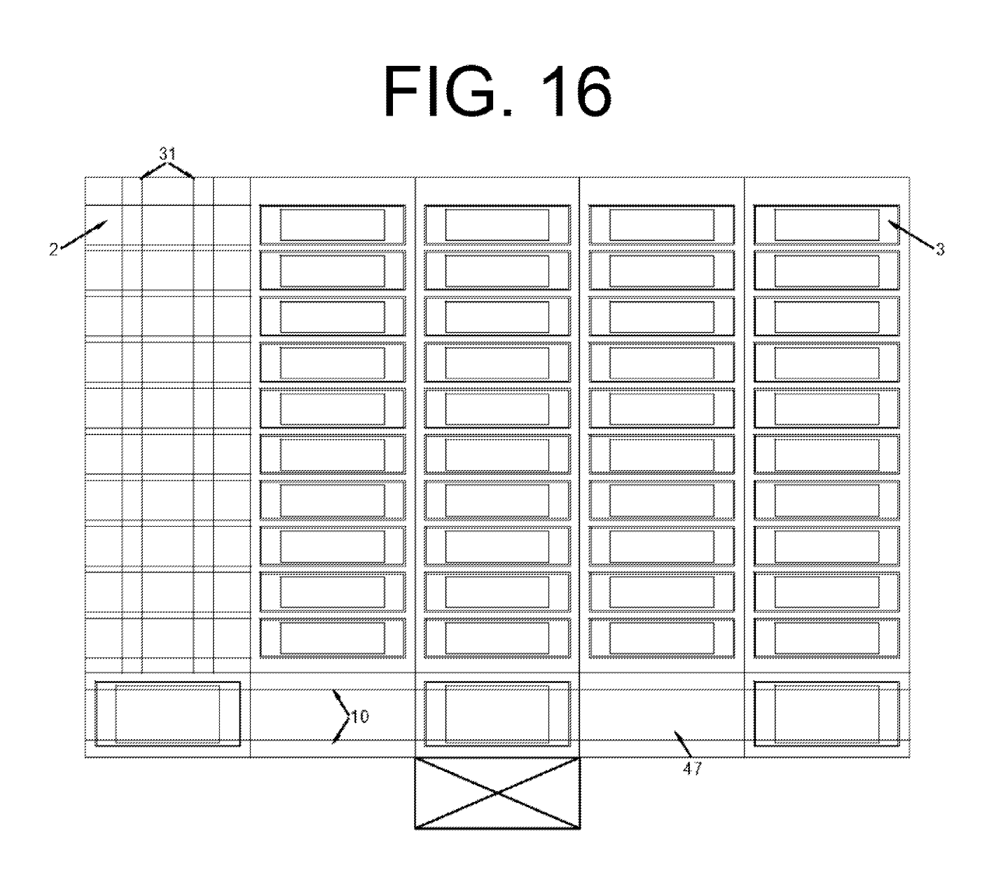

FIG. 16 is an illustration of a further example embodiment compatible with sequential, first-in-last-out, or first-in-first-out operations. For example, if retrieval is sequential, like in a container manufacturing plant, bus depot, car warehouse, cars stored in ports, etc., a storage complex may have multi-tiers with equal heights. One or more elevator assemblies 4 can be oriented at one end of the complex. In each tier, a common causeway may run in front of elevator 4 and provide track for transfer modules. One or more transfer modules may run on fixed first track 10. Each transfer module may serves one or more transfer arms. Addressed storage slots may be organized as rows and bays with no space in between to allow for packed storage, as shown in FIG. 16.

It is understood that example embodiments are useable with containers of all sizes. When a transfer channel is required to move containers of varying sizes, containers may be moved lengthwise, because containers have almost uniform width. In this example, a turn table arrangement may be installed between a transfer channel and a buffering bay assembly near a storage tower to align with the storage tower layout for further handling at storage tower. It is further understood that example embodiments are compatible with end-to-end automation, permitting a central computer to direct all action required to store, handle, and/or retrieve containers, thus greatly increasing efficiency. It is further understood that example embodiments may be useable with selective container retrieval, allowing for individualized container storage and handling even through a single access point. It is further understood that example embodiments may provide fuller support for containers about their base throughout handling, without need to grip container reinforcements or permitting containers to slide or tip during handling due to incomplete support or external forces like wind.

Example embodiments thus being described, it will be appreciated by one skilled in the art that example embodiments may be varied through routine experimentation and without further inventive activity. For example, although example embodiments are shown using tracks for movement, wheels, or above-supporting pulleys and platforms, low-friction glides, etc. are equally useable in example embodiments. Variations are not to be regarded as departure from the spirit and scope of example embodiments, and all such modifications as would be obvious to one skilled in the art are intended to be included within the scope of the following claims.

What is claimed is:

1. An automated storage and retrieval system for a storage facility having a loading/unloading area and containers stored in assigned spaces, the system comprising:
a mobile transfer assembly movable along a line of the assigned spaces and including a mobile transfer arm moveable in a direction not parallel to the line and between the mobile transfer assembly and the assigned spaces to move the containers into the mobile transfer assembly; and
a buffer bay between the mobile transfer assembly and the loading/unloading area and shaped to receive the containers, wherein the buffer bay includes,
side structures positioned to support and guide the containers through the buffer bay, and
a buffer transfer arm moveable across the buffer bay, wherein the buffer transfer arm includes a lift structure configured to lower and raise to selectively avoid the containers or contact the containers so as to move the containers through the buffer bay with the buffer transfer arm.

2. The system of claim 1, wherein the assigned spaces and the loading/unloading area are at different elevations, the system further comprising:
an elevator shaped to receive the containers and moveable between the different elevations, wherein the elevator includes an elevator transfer arm moveable between the elevator and the buffer bay and configured to move the containers between the elevator and the buffer bay.

3. The system of claim 2, wherein the storage facility includes a plurality of levels with the assigned spaces, and wherein the elevator is moveable between each level, the system further comprising:
a plurality of the mobile transfer assemblies, at least one on each of the levels with the assigned spaces.

4. The system of claim 3, further comprising:
tracking along the line, in the elevator, on the mobile transfer assembly, and in the buffer bay, wherein the mobile transfer assembly is configured to move on the tracking along the line, wherein the mobile transfer arm is configured to move on the tracks on the mobile transfer assembly, wherein the buffer transfer arm is configured to move on the tracks in the buffer bay, and wherein the elevator transfer arm is configured to move on the tracks in the elevator, along the line, and in the buffer bay.

5. The system of claim 1, further comprising:
a central system controller communicatively connected to and controlling the mobile transfer assembly, the mobile transfer arm, and the buffer transfer arm.

6. The system of claim 1, wherein the line and the direction are transverse to each other, wherein the buffer bay extends longest along the line and the loading/unloading area is at an end of the extension of the buffer bay.

7. The system of claim 1, further comprising:
transfer equipment in the loading/unloading area configured to move the containers between the buffer bay and a destination/source.

8. The system of claim 1, wherein the mobile transfer assembly includes an upper level and a lower level, wherein the upper level fully supports and secures the containers, and wherein the lower level is open above and is positioned below the upper level a sufficient distance to permit the mobile transfer arm to travel under the containers on the upper level.

9. The system of claim 1, wherein the buffer bay includes an upper level and a lower level, wherein the upper level includes the side structures and fully supports the containers, and wherein the lower level is open above and is positioned below the upper level a sufficient distance to permit the buffer transfer arm to travel under the containers on the upper level when the lift structure is lowered.

10. The system of claim 1, wherein the storage facility includes a plurality of levels with the assigned spaces, the system further comprising:
an elevator shaped to receive the containers and moveable between the levels and the buffer bay, wherein the elevator includes an elevator transfer arm moveable between the elevator and the levels and moveable between the elevator and the buffer bay, wherein the elevator transfer arm and the buffer transfer arm each include a lift structure configured to lower and raise to selectively avoid the containers or contact the containers so as to move the containers, and wherein the mobile transfer assembly, the buffer bay, and the elevator each include,
an upper level and a lower level, wherein the upper levels fully support and secure the containers, and wherein the lower levels are open above and positioned below the upper level a sufficient distance to permit the mobile transfer arm, the elevator transfer arm, and the buffer transfer arm to travel under the containers on the upper levels, and
tracks on the lower level on which the mobile transfer arm, the elevator transfer arm, and the buffer transfer arm travel.

11. The system of claim 10, wherein the lifting devices each include contact arms and an electromagnet to secure the containers to, and move the containers with, the elevator arm, the buffer transfer arm, and the mobile transfer arm, and wherein the mobile transfer arm, the elevator arm, and the buffer transfer arm each include a local drive to be self-propelled.

12. An automated storage and retrieval system for a multi-level storage facility having a loading/unloading area and containers stored in assigned spaces, the system comprising:
an elevator moveable between a first level having the assigned spaces and a second level different from the first level and having the loading/unloading area;
a first handling arm on the first level and moveable between the assigned spaces and the elevator;
a second handling arm on the second level and moveable between the elevator and the loading/unloading area, wherein the first and the second handling arms may be raised and lowered to selectively contact and move the containers with the arms; and
a controller communicatively connected to and coordinating the elevator, first handling arm, and second handling arm to automatically move each package completely from the loading/unloading area in to one of the assigned spaces and vice versa.

13. The system of claim 12, wherein the first handling arm and the second handling arm each move on fixed tracks in up to two transverse directions and include an electromagnet and frictional arms to rigidly secure the containers for co-movement with one of the first and the second handling arms.

14. The system of claim 13, wherein the elevator, the first handling arm, and the second handling arm are each configured to be simultaneously moving a unique container.

15. The system of claim 12, further comprising:
a third handling arm in the elevator and moveable between the first level and the second level, wherein the controller is further communicatively connected to and coordinating the elevator, first handling arm, second handling arm, and third handling arm to automatically move each package completely from the loading/unloading area in to one of the assigned spaces and vice versa.

16. A method of storing containers in a multi-level storage facility having a loading/unloading area and assigned spaces for the containers with a handling and storage system including, an elevator moveable between a first level having the assigned spaces and a second level different from the first level and having the loading/unloading area, a first handling arm on the first level and moveable between the assigned spaces and the elevator, a second handling arm on the second level and moveable between the elevator and the loading/unloading area, wherein the first and the second handling arms may selectively move the containers with the arms, and a controller communicatively connected to and coordinating the elevator, first handling arm, and second handling arm, the method comprising:
assigning, with the controller, one of the assigned slots for one of the containers arriving at the facility;
receiving the container in the loading/unloading area;
first moving, with the controller controlling the second handling arm, the container to the elevator;
lifting, with the controller controlling the elevator, the container from the second level to the first level; and
second moving, with the controller controlling the first handling arm, the container to the assigned slot from the elevator.

17. The method of claim 16, wherein the first handling arm travels on a transfer assembly, and wherein the second moving includes transferring the container in a first direction from the elevator to the transfer assembly, moving in a second direction different from the first the container on the transfer assembly to the assigned slot, and transferring the container in the first direction from the transfer assembly to the slot.

18. The method of claim 16, wherein the elevator includes an elevator arm, and wherein the first moving includes transferring the container into the elevator with the controller controlling the elevator arm, and wherein the second moving includes transferring the container out of the elevator with controller controlling the elevator arm.

19. The method of claim 16, wherein the first moving and the second moving include moving the container on fixed tracks entirely between the loading/unloading area and the assigned space and by securing the container to the arms with electromagnets.

20. The method of claim 16, wherein the receiving includes loading the container from a vehicle with transfer equipment controlled by the controller into the loading/unloading area.
